(19) United States
(12) Patent Application Publication
(10) Pub. No.: US 2011/0171388 A1
(43) Pub. Date: Jul. 14, 2011

(54) PRIMERS COMPRISING CERIUM PHOSPHATE

(75) Inventors: Keith A. Rawlins, Cedar Lake, IN (US); Wai-Kwong Ho, North Olmsted, OH (US); Joseph K. Walker, Mentor, OH (US); Charles H. Simpson, Avon, OH (US); Frank K. Bonney, Gary, IN (US)

(73) Assignee: THE SHERWIN-WILLIAMS COMPANY, Cleveland, OH (US)

(21) Appl. No.: 12/984,866

(22) Filed: Jan. 5, 2011

Related U.S. Application Data
(60) Provisional application No. 61/292,333, filed on Jan. 5, 2010.

(51) Int. Cl. B05D 5/00; C09D 163/00; B05D 1/38; B05D 3/00

(52) U.S. Cl. 427/386; 523/402

(57) ABSTRACT

A coating composition comprising:
(i) at least one polyepoxide;
(ii) at least one polyvinyl butyral resin;
(iii) a corrosion inhibiting amount of cerium phosphate;
(v) phosphoric acid;
(v) a water miscible organic solvent; and
(vii) water;
   wherein the coating composition is free of hexavalent chromium.

This application claims the benefit of U.S. provisional patent application No. 61/292,333 filed on Jan. 5, 2010, the entirety of which is hereby incorporated by reference.

This invention relates to coating compositions for use as primers, and for some applications, as wash primers. The compositions comprise cerium phosphate as a corrosion inhibiting pigment.

Wash primers are thin coating compositions of a vinyl acetal, usually vinyl butyral, resin in an organic solvent and catalyzed with phosphoric acid. Wash primers passivate the surface of a substrate and provide enhanced corrosion resistance and adhesion for subsequent coats of paint. Frequently the wash primers would include a corrosion inhibiting pigment. Chromate pigments, such as zinc chromate, provide excellent corrosion resistance. However, chromates, especially hexavalent chromium compounds, are undesirable due to their toxicity, and they have been banned or severely regulated in many applications.

It would be desirable, therefore, to provide a primer coating composition, and in particular, a wash primer composition, that provides excellent corrosion resistance but is free of hexavalent chromium or other potentially harmful corrosion inhibitors.

In one embodiment, there is provided a wash primer coating composition comprising: (i) a polyepoxide; and (ii) a polyvinyl butyral resin; and (iii) a corrosion inhibiting amount of cerium phosphate; and (iv) phosphoric acid; and (v) a water miscible organic solvent; and (vi) water, wherein the coating composition is substantially free of hexavalent chromium containing materials. In one useful embodiment, the coating is provided as a multi-component coating wherein the components are reactive upon mixing, and wherein the first component comprises (i) a polyepoxide; (ii) a polyvinyl butyral resin; and (iii) a corrosion inhibiting amount of cerium phosphate; and wherein the second component comprises phosphoric acid and wherein either the first component or the second component or both will also comprise a water miscible solvent and/or water. In another embodiment, the coating also comprises a silane.

A method of treating a substrate is also provided. The method comprises applying the coating of this invention to at least one surface of the substrate. Once this composition has been applied to the substrate and allowed to cure or dry an additional primer and/or one or more topcoats can also be applied thereto.

### 1. Polyepoxides

The coating composition comprises at least one epoxy functional compound and mixtures of different polyepoxides can also be used.

Representative useful polyepoxides can be any polyepoxide having an average of at least 2.0 epoxy groups per molecule and include the glycidyl ethers of aliphatic or aromatic diols or polyols such as the polyepoxy functional novolac, bisphenol and aliphatic and cycloaliphatic epoxies. Some specific examples of useful polyepoxides include butanediol diglycidyl ether, neopentylglycol diglycidyl ether, diglycidyl 1,2-cyclohexanedicarboxylate, poly(propylene glycol) diglycidyl ether, resorcinol diglycidyl ether, triglycidyl ethers of glycerin, triglycidyl isocyanurate, trimethylolpropane triglycidyl ether, novolac epoxy resins, bisphenol A epoxy resins, etc. Some useful commercial examples of these polyepoxides include those sold under the Epon® trademark from Hexion. Polyglycidyl ethers are well known in the art and can be conveniently prepared by the reaction of an epihalohydrin, such as epichlorohydrin, with a compound having at least two hydroxyl groups, such as an aliphatic or cycloaliphatic polyol or a polyhydric phenol. Other polyepoxides include the glycidyl esters, such as those typically obtained by the reaction of polycarboxylic acids with epihalohydrins and alkali metal hydroxides. Epoxy novolac resins are useful in some embodiments of this invention, and are representatively prepared by reacting an epihalohydrin with the condensation product of an aldehyde with a polyhydric phenol.

Commercial examples of representative cycloaliphatic epoxies include 3,4-epoxycyclohexylmethyl 3,4-epoxy cyclohexane carboxylate; bis(3,4-epoxycyclohexylmethyl)adipate; 3,4-epoxy-6-methylcyclohexylmethyl 3,4-epoxy-6-methylcyclohexane carboxylate; bis(3,4-epoxy-6-methylcyclohexylmethyl)adipate; bis(2,3-epoxycyclopentyl)ether; dipentene dioxide; 2-(3,4-epoxycyclohexyl-5,5-spiro-3-4-epoxy) cyclohexane-metadioxane. Other commercially available cycloaliphatic epoxies include CY 192, a cycloaliphatic diglycidyl ester epoxy resin having an epoxy equivalent weight of about 154. The manufacture of representative cycloaliphatic epoxies is taught in various patents including U.S. Pat. Nos. 2,750,395; 2,884,408; 2,890,194; 3,027,357 and 3,318,822.

Other useful epoxies include epoxidized oils and acrylic polymers derived from ethylenically unsaturated epoxy-functional monomers such as glycidyl acrylate or glycidyl methacrylate in combination with other copolymerizable monomers such as the (meth)acrylic and other unsaturated monomers. Representative useful (meth)acrylic monomers include methyl acrylate, ethyl acrylate, propyl acrylate, isopropyl acrylate, butyl acrylate, isobutyl acrylate, ethyl hexyl acrylate, amyl acrylate, 3,5,5-trimethylhexyl acrylate, methyl methacrylate, lauryl methacrylate, butyl methacrylate, acrylonitrile, methacrylonitrile, acrylamide and methacrylamide. Other copolymerizable monomers include vinyl acetate, vinyl propionate, vinyl butyrate, vinyl isobutyrate, vinyl benzoate, vinyl m-chlorobenzoate, vinyl p-methoxy benzoate, vinyl chloride, styrene, alpha-methyl styrene, diethyl fumarate, dimethyl maleate, etc. For some embodiments polyepoxides based upon epichlorohydrin and bisphenol A are useful.

### 2. Polyvinyl Butyral Resin

Polyvinyl acetals, such as polyvinyl butyral, are typically obtained by acetalyzing polyvinyl alcohol under acidic conditions with an aldehyde compound, such as butyraldehyde for butyral resins. Polyvinyl alcohol generally has vinyl alcohol units and vinyl ester units. Therefore, polyvinyl butyral resins obtained through acetalization of such polyvinyl alcohol typically comprise at least three types of functional segments, vinyl acetal units, hydroxyl units, and butyral units.

For some embodiments, the polyvinyl butyral resins will have a butyral % of about 70-90 (expressed as % polyvinyl butyral), an acetate % of about 0.1 to 5.0 (expressed as % polyvinyl acetate) and a hydroxyl % (expressed as ° A) polyvinyl alcohol) of about 5-29. Mixtures of different polyvinyl butyrals can be used.

### 3. Cerium Phosphate

The coating compositions will also comprise a corrosion inhibiting amount of cerium (III) phosphate.

The cerium phosphate need only be present in the coating in an amount to provide the desired level of corrosion resistance. Typically the cerium phosphate will be present at a level of at least about 0.5%, and for some embodiments at least 8.0%, and for some embodiments at least 20%, by weight of the total weight solids of the polyepoxide, polyvinyl butyral resin, and cerium phosphate combined. For some embodiments the cerium phosphate will be present at a level between about 20 and 50% by weight of the total weight solids of the polyepoxide, polyvinyl butyral resin, and cerium phosphate combined. Additional corrosion inhibiting chemicals and pigments can also be incorporated into the composition, however, for some applications, it is desirable that the composition be substantially free of a strong anodic corrosion inhibitor. By “substantially free of a strong anodic corrosion inhibitor” is meant that a such an inhibitor would not be present at a level to contribute measurably to corrosion protection and if present at all would typically be present at a level of less than 0.25% by weight of the entire paint. By a “strong anodic corrosion inhibitor” is meant a compound that is soluble in alkaline media, while precipitating as a reduced, insoluble oxide under neutral and acidic reducing conditions, that is, existing as an insoluble oxide below −600 my vs Ag/AgCl at pH 7, and below −300 my vs Ag/AgCl at pH 2.

The ratios of the polyepoxide, the polyvinyl butyral resin, and the cerium phosphate within the composition can vary depending upon the intended application. For some embodiments, the polyepoxide and the polyvinyl butyral resin will be present at a level to provide a weight solids ratio of polyepoxide to polyvinyl butyral resin between 15:85 and 85:15, and for some embodiments between 40:60 and 60:40.

### 4. Phosphoric Acid

The coating compositions of this invention will also comprise phosphoric acid. The phosphoric acid acts as an acid etch to etch the substrate upon application to provide enhanced adhesion, and also acts to catalyze the curing reaction of the polyvinyl butyral resin and the polyepoxides. Although it is not our intent to be bound by theory, and the curing reaction may be somewhat complex, it is generally believed that the acid catalyzes the reaction of the hydroxyl groups of the polyvinyl butyral resin to react with the epoxy groups of the polyepoxide and also catalyzes the reaction of the polyvinyl butyral resin with itself through transacetalization or possibly reactions of acetate and hydroxyl groups. For some embodiments, the phosphoric acid will be present at level to provide at least 0.1 parts by weight for each 1.0 part by weight solids of the polyvinyl butyral resin, and for some embodiments will be present at a level of between about 0.2 and 0.7 for each 1.0 part weight solids of the polyvinyl butyral resin.

### 5. Water Miscible Organic Solvents

The coatings may also include organic solvents. Useful water miscible organic solvents include alcohols, ether alcohols, ketones, and esters.

At least a small amount of water should also be present in the coating compositions to provide solubility and miscibility to the phosphoric acid. For many embodiments the water will be present at a level of at least about 0.1% based upon the total weight of the coating.

The coating composition can also comprise one or more pigments in addition to the cerium phosphate such as titanium dioxide, talc, silicas, barites, clay, or calcium carbonate.

The coating composition can additionally contain conventional additives such as silanes, titanates, flow agents, wetting agents, dispersants, adhesion promoters, thickeners, etc. Silane additives are useful in some embodiments. The silane additives, if used, need only be present at a level to provide the desired degree of additional adhesion promotion and/or crosslinking. Typically the silane would be present at a level of at least about 0.5% by weight based upon the total weight solids of polyepoxide and polyvinyl butyral resin in the system. For some embodiments it is useful to have a level of silane from about 2 to about 15% by weight, and sometimes from about 4 to about 10%. For some embodiments it is useful to incorporate an epoxy silane additive as the silane. The epoxy silane should have at least one epoxy group and at least one silane ether group. Some representative epoxy silanes include 3-glycidoxypropyltrimethoxysilane, 3-glycidoxypropyltriethoxysilane, 3-glycidoxypropylmethyldiethoxysilane, 3-glycidoxypropylmethyldimethoxysilane, beta-(3,4-epoxycyclohexyl) ethyltriethoxysilane, etc.

The coating composition can be applied to any articles or surfaces that are to be protected. Particular substrates which can be treated with these coatings include ferrous metals, aluminum and aluminum alloys.

The invention is described further by the following example, which is intended to be illustrative and by no means limiting. All references to parts and percentages are by weight unless otherwise indicated.

### EXAMPLE 1

### Preparation of Corrosion Inhibiting Wash Primer

The following formula could be used to prepare a two component corrosion inhibiting wash primer:

Component A

| RAW MATERIAL | PARTS BY WEIGHT |
|---|---|
| Commercial Epoxy¹ | 49.2 |
| Commercial Epoxy 2² | 33.9 |
| epoxy silane³ | 8.7 |
| polyvinyl butyral resin⁴ | 356.0 |
| dispersant | 6.5 |
| cerium phosphate | 38.2 |
| barium sulfate | 15.6 |
| Black iron oxide | 1.5 |
| fumed silica | 55.0 |
| parachlorobenzotriflouride | 256.6 |
| methyl acetate | 54.7 |
| t-butyl acetate | 35.0 |

¹Epon ® 1007 diglycidyl ether of bisphenol A from Hexion, weight per epoxy 1600-2300, 55% NVM in methylamyl ketone
²Epon ® 1001 diglycidyl ether of bisphenol A from Hexion, weight per epoxy 450-550, 80% NVM in methyl ethyl ketone
³Coatosil ® 1770 epoxy silane beta-(3,4-epoxycyclohexyl) ethyltriethoxysilane
⁴Butvar ® B76 from Solutia, 15.2% NVM in methyl acetate and diacetone alcohol. The Butvar ® B76 has a hydroxyl content (expressed as % polyvinyl alcohol) of 11.5-13.5, an acetate content (expressed as % polyvinyl acetate) of 2.5% maximum, a butyral content (expressed as % polyvinyl butyral) of 88% and a weight average molecular weight (measured by size exclusion chromatography) of 90,000-120,000

Component B

| RAW MATERIAL | PARTS BY WEIGHT |
|---|---|
| methyl acetate | 225.6 |
| diacetone alcohol | 20.5 |
| deionized water | 6.8 |
| 75% phosphoric acid | 17.9 |
| Acetone | 434.6 |

Components A and B could be mixed prior to application in a 1:2 volume ratio to provide a wash primer of approximately 3.50 pounds/gallon VOC (volatile organic content) which would be free of hazardous air pollutants (HAPS). The coatings of this invention can be applied by any conventional method including spray, dipping, brushing etc. Typically the wash primer will be applied to provide a dry film thickness of at least about 0.1 mils and for some embodiments from about 0.2 to about 0.6 mils.

Normally, a substrate coated with the wash primer of this invention will also subsequently be coated with one or more additional coats of primer and/or topcoats. The primers or topcoats can be any type known in the industry and could include solvent or waterborne primers and topcoats. A primer, if desired, would typically be applied to provide a dry film thickness of at least about 0.1 mils and for some embodiments from about 0.2 to about 1.0 mils. Epoxy primers and zinc rich primers are useful in some embodiments. One or more topcoats can also be applied to the wash primer, or to the primed surface of the substrate. For some embodiments curable topcoats such as polyurethanes, polyureas, polyepoxides and the like are useful as topcoats. For many applications, the topcoats will be applied to provide a dry film thickness of at least about 0.3 mils and often will range from about 0.5 to about 20 mils.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

We claim:

1. A coating composition comprising:
(i) at least one polyepoxide;
(ii) at least one polyvinyl butyral resin;
(iii) a corrosion inhibiting amount of cerium phosphate;
(iv) phosphoric acid;
(v) a water miscible organic solvent; and
(vii) water;
wherein the coating composition is free of hexavalent chromium.

2. The composition of claim 1 wherein the cerium phosphate is present at a level of at least 0.5% by weight of the total weight solids of polyepoxide, polyvinyl butyral and cerium phosphate combined.

3. The composition of claim 2 wherein the cerium phosphate is present at a level of at least 8% by weight of the total weight solid of polyepoxide, polyvinyl butyral and cerium phosphate combined.

4. The composition of claim 2 wherein the cerium phosphate is present at a level between about 20% and 50% by weight of the total weight solid of polyepoxide, polyvinyl butyral and cerium phosphate combined.

5. The composition of claim 1 wherein the polyepoxide and the polyvinyl butyral are present at a level to provide a weight solids ratio of polyepoxide to polyvinyl butyral resin between 15:85 and 85:15.

6. The composition of claim 1 wherein the polyepoxide and the polyvinyl butyral are present at a level to provide a weight solids ration of polyepoxide to polyvinyl butyral resin between 40:60 and 60:40.

7. The composition of claim 1 wherein the composition also comprises a silane.

8. The composition of claim 7 wherein the silane is an epoxy silane.

9. The composition of claim 8 wherein the epoxy silane is present at a level of at least 0.5% by weight based upon the total weight solids of polyepoxide and polyvinyl butyral resin in the system.

10. The composition of claim 9 wherein the epoxy silane is present at a level of about 2 to about 15% based upon the total weight solids of polyepoxide and polyvinyl butyral resin in the system.

11. The composition of claim 9 wherein the epoxy silane is present at a level of silane from about 4 to about 10% based upon the total weight solids of polyepoxide and polyvinyl butyral resin in the system.

12. The composition of claim 1 wherein the composition is substantially free of a strong anodic corrosion inhibitor.

13. A process of treating a substrate which process comprises:
(1) applying a wash primer to the substrate and allowing the wash primer to cure or dry to produce a coated substrate;
(2) applying at least one other primer and/or topcoat to the coated substrate;
and wherein the wash primer comprises:
(i) at least one polyepoxide;
(ii) at least one polyvinyl butyral resin;
(iii) a corrosion inhibiting amount of cerium phosphate;
(iv) phosphoric acid;
(v) a water miscible organic solvent; and
(vii) water;
and wherein the wash primer is free of hexavalent chromium.

14. The process of claim 13 wherein the substrate comprises aluminum or an aluminum alloy.

15. The process of claim 13 wherein the substrate comprises a ferrous substrate.
